(19) United States
(12) Patent Application Publication
(10) Pub. No.: US 2024/0135274 A1
(43) Pub. Date: Apr. 25, 2024

(54) FRICTIONLESS, SECURE METHOD TO DETERMINE DEVICES ARE AT THE SAME LOCATION

(71) Applicant: GOOGLE LLC, Mountain View, CA (US)

(72) Inventors: Omer Livne-Simha, Mountain View, CA (US); Gil Disatnik, Kibbutz Yakum (IL)

(21) Appl. No.: 18/544,788

(22) Filed: Dec. 19, 2023

Related U.S. Application Data
(63) Continuation of application No. 16/609,027, filed on Oct. 28, 2019.
(60) Provisional application No. 62/845,639, filed on May 9, 2019.

(51) Int. Cl. G06Q 10/0631; G06Q 30/018; H04W 4/02; H04W 4/024; H04W 4/40

(52) U.S. Cl. CPC G06Q 10/0631; G06Q 30/0185; H04W 4/023; H04W 4/024; H04W 4/40

(57) ABSTRACT

To determine whether two or more devices are at the same location, a first client device receives a first short-range communication from a second client device identifying the second client device. The first client device also receives a second short-range communication from the second client device identifying the second client device. The first client device provides the first and second short-range communications to a server device that analyzes the first and second short-range communications to verify that the first and second client devices are the same location. More specifically, the server device determines a likelihood that the first and second client devices are the same location based on the first and second short-range communications. Then the server devices determines a risk of fraud based on the likelihood.

### CROSS-REFERENCE TO RELATED APPLICATIONS

This application is a continuation of U.S. patent application Ser. No. 16/609,027 entitled “Frictionless, Secure Method to Determine Devices are at the Same Location,” filed on Oct. 28, 2019, which is a national stage application of PCT/US19/40059 filed Jul. 1, 2019, which claims priority to and the benefit of the filing date of U.S. Provisional Patent Application No. 62/845,639 entitled “Frictionless, Secure Method to Determine Devices are at the Same Location,” filed on May 9, 2019, the entire disclosures of each of which are hereby expressly incorporated by reference.

### FIELD OF THE DISCLOSURE

The present disclosure relates to fraud detection systems, and more particularly, to determining devices are at the same location based on signals received at each of the devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, ridesharing or carpooling providers connect drivers and passengers to arrange for a driver to transport a passenger to a destination. Typically, a passenger or driver manually confirms that the passenger has entered the driver's vehicle at the beginning of the trip. However, manual confirmation may be vulnerable to fraudulent activity. Other systems also may need to determine that multiple users are in the same location. However, these systems are vulnerable to spoofing attacks which can also lead to fraud.

### SUMMARY

To determine that two client devices are at the same location, a location determination system receives an indication that multiple client devices are at the same location, and receives information from the client devices which may be used to verify that the client devices are at the same location. The information used to verify that the client devices are at the same location may include a first short-range communication, such as a radio communication transmitted by a first client device and received at a second client device. The information may also include a second short-range communication, such as an ultrasonic or near-ultrasonic communication. The radio and ultrasonic communications may include identification information for the device that transmitted the communication, so that the location determination system can verify that the communication received at the second client device came from the first client device.

Additionally, the information may include sensor data detected by sensors in each of the client devices. For example, in a ridesharing or carpooling environment both client devices may be located within the same vehicle during a trip. Accordingly, both client devices may collect similar sensor data, such as acceleration data, velocity data, location data, pressure data, orientation data, gyroscope data, etc. Moreover, the information may include additional devices other than the first and second client devices at the location which may be detected from communication signals, such as Wi-Fi, Bluetooth™, near field communication (NFC), etc. The additional devices may include a vehicle head unit, for example. The signals from the additional devices may be used as an “environmental fingerprint” to fingerprint the surrounding environment for the first and second client devices based on the radio identifiers in the surrounding area of each respective client device.

The location determination system may then analyze each type of information to determine whether the first and second client devices are at the same location. In some implementations, the location determination system may determine a likelihood that the first and second client devices are at the same location based on each type of information, and assign a score to each type of information based on the corresponding likelihood. The location determination system may then aggregate or combine the scores in any suitable manner to generate an overall score. In some implementations, the location determination system determines whether users of the first and/or second client devices are new users and adjusts the overall scores based on whether one or both of the users are new users. When the overall score is below a threshold score, the location determination system may identify a risk of fraud and prevent the first and/or second client devices from receiving any benefits for being at the same location. On the other hand, when the overall score is at or above the threshold score, the location determination system may determine that the first and second client devices are at the same location, and may provide benefits to the first and/or second client devices for being at the same location.

One example embodiment of the techniques of this disclosure is a method for securely determining whether two or more devices are at a same location. The method includes receiving, at a server device from a first client device, an indication that the first client device and/or a second client device are at a same location, receiving, from the first client device, an indication of a first short-range communication received at the first client device, via a first short-range communication link, from the second client device, and receiving, from the first client device an indication of a second short-range communication received at the first client device, via a second short-range communication link, from the second client device, where the first and second short-range communications identify the second client device. The method further includes analyzing the indication of the first short-range communication and the indication of the second short-range communication to determine a likelihood that the first client device and the second client device are at the same location, and in response to determining that the likelihood is less than a threshold likelihood, identifying a risk of fraud regarding whether the first client device and the second client device are at the same location.

Another example embodiment of the techniques of this disclosure is a server device for securely determining whether two or more devices are at a same location. The server device includes one or more processors and a non-transitory computer-readable memory coupled to the one or more processors and storing instructions thereon. When executed by the one or more processors, the instructions cause the server device to receive, from a first client device, an indication that the first client device and/or a second client device are at a same location, receive, from the first client device, an indication of a first short-range communication received at the first client device, via a first short-range communication link, from the second client device, and receive, from the first client device, an indication of a second short-range communication received at the first client device, via a second short-range communication link, from the second client device, where the first and second short-range communications identify the second client device. The instructions further cause the server device to analyze the indication of the first short-range communication and the indication of the second short-range communication to determine a likelihood that the first client device and the second client device are at the same location, and in response to determining that the likelihood is less than a threshold likelihood, identify a risk of fraud regarding whether the first client device and the second client device are at the same location.

Yet another example embodiment of the techniques of this disclosure is a method for securely determining whether two or more devices are at a same location. The method includes receiving, at a first client device, a first short-range communication from a second client device via a first short-range communication link, and receiving a second short-range communication from the second client device via a second short-range communication link, where the first and second short-range communications identify the second client device. The method further includes determining that the first and second client devices are at a same location based on the first and second short-range communications from the second client device, and transmitting, to a server device, an indication that the first and second client devices are at the same location with information indicative of the locations of the first and second client devices for the server device to verify that the first and second client devices are at the same location.

### BRIEF DESCRIPTION OF THE DRAWINGS

FIG. 1 illustrates an example vehicle in which the techniques of the present disclosure can be used to determine that two client devices are at the same location;

FIG. 2 is a block diagram of an example driver client device, and an example rider client device that can operate in the system of FIG. 1;

FIG. 3 is a block diagram of an example communication system in which the driver client device and the rider client device of FIG. 1 can operate;

FIG. 4 is a messaging diagram illustrating example signals received or detected at the driver client device and the rider client device and provided to the location determination server to verify that the client devices are at the same location;

FIG. 5 is a flow diagram of an example method for securely determining whether two or more devices are at the same location, which can be implemented in a server device; and

FIG. 6 is a flow diagram of an example method for providing information indicating that two or more devices are at the same location, which can be implemented in a client device.

### DETAILED DESCRIPTION

### Overview

In some scenarios, there is a need to determine whether two client devices are in the same location, such as in a ridesharing or carpooling service, for determining whether a passenger and a driver are in the same vehicle. More specifically, this applies to a scenario where several users of a ridesharing or carpooling application agree to share location and/or identity information to verify that a driver has picked up passengers, for example. One way to achieve this is for each client device to send its GPS coordinates to a server, which can compare the coordinates to determine whether the client devices are at the same location. However, this technique is insecure. In particular, either or both of the client devices can provide falsified GPS coordinates to the server, so as to mislead the server into making an incorrect determination that the client devices are at the same location.

The present disclosure provides a more secure technique for verifying whether two client devices are at the same location. In accordance with the present disclosure, short-range communication is used to verify whether two client devices are at the same location. More specifically, a first client device transmits data using a short-range communication technique, such as Bluetooth™ Low Energy (BLE) or ultrasound/near-ultrasound. The data transmitted by the first client device can be received by a second client device that is within the range of the first client device. Thus, by determining that the second client device has successfully received the data transmitted by the first client device, it can be verified that the first and second client devices are at the same location.

In some embodiments, two different short-range communication links are used. This can improve the security of the method, by increasing the effort required to spoof the system by introducing falsified data. The use of two short-range communication links can also improve reliability, by providing redundancy in the event that one of the short-range communication links is inoperative. Furthermore, in some embodiments, the first client device identifies itself to the second client device via an encrypted short-range communication. The encrypted short-range communication may then be decrypted by a server to identify the first client device and further prevent spoofing.

### Example Hardware and Software Components

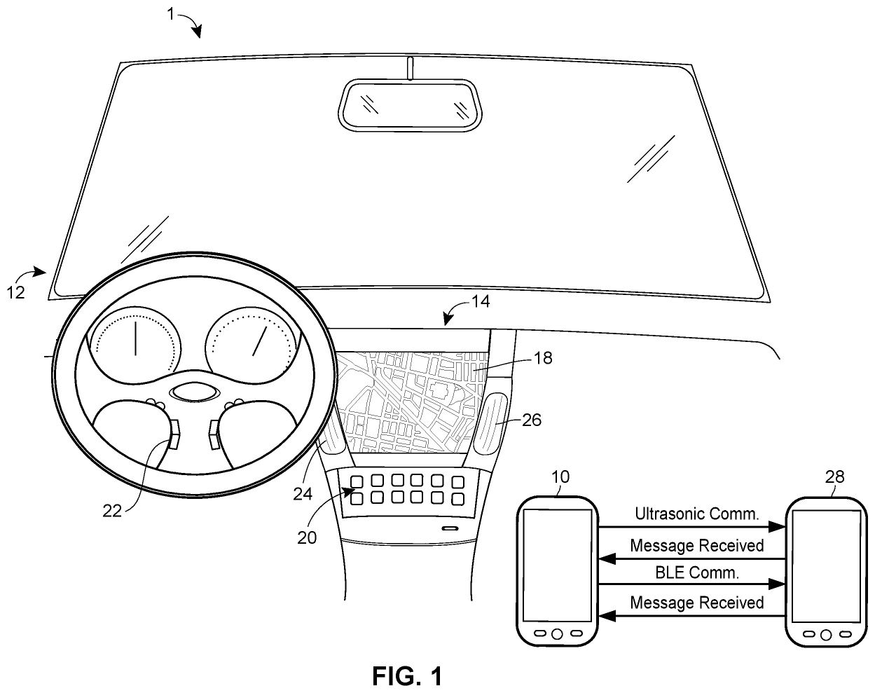

Referring to FIG. 1, an example environment 1 in which the techniques outlined above can be implemented includes a driver client device 10, a rider client device 28, and a vehicle 12 with a head unit 14. The driver client device 10 may be a smart phone, a tablet computer, a laptop computer, or a wearable computing device, for example. Moreover, the rider client device 28 may also be a smart phone, a tablet computer, a laptop computer, or a wearable device, for example. The driver client device 10 and the rider client device 28 can communicate with various content providers, servers, etc. via a wireless communication network such as a fourth- or third-generation cellular network (4G or 3G, respectively). Further, the driver client device 10 may communicate with the rider client device 28 via a first short-range communication link which may be a radio communication link, such as for example, Bluetooth™ (e.g., BLE), Wi-Fi Direct, ZigBee, NFC, etc. Additionally, the driver client device 10 may communicate with the rider client device 28 via a second short-range communication link which may be an ultrasonic or near-ultrasonic communication link. The rider client device 28 may also communicate with various content providers, servers, etc. via a wireless long-range communication network such as a fourth- or third-generation cellular network (4G or 3G, respectively) and/or the Internet.

The head unit 14 can include a display 18 for presenting navigation information such as a digital map. The display 18 in some implementations is a touchscreen and includes a software keyboard for entering text input, which may include the name or address of a destination, point of origin, etc. Hardware input controls 20 and 22 on the head unit 14 and the steering wheel, respectively, can be used for entering alphanumeric characters or to perform other functions for requesting navigation directions. The head unit 14 also can include audio input and output components such as a microphone 24 and speakers 26, for example. Moreover, the head unit 14 can communicate with various content providers, servers, etc. via a wireless long-range communication network such as a fourth- or third-generation cellular network (4G or 3G, respectively) and/or the Internet. While the driver client device 10 is shown in FIG. 1 as a smart phone, this is for ease of illustration only. The driver client device 10 and/or the rider client device 28 may include any suitable type of portable or non-portable computing device, including a vehicle head unit. More specifically, the driver client device 10 may include the head unit 14 which may communicate with a rider client device 28 such as a smart phone to determine that the devices are at the same location.

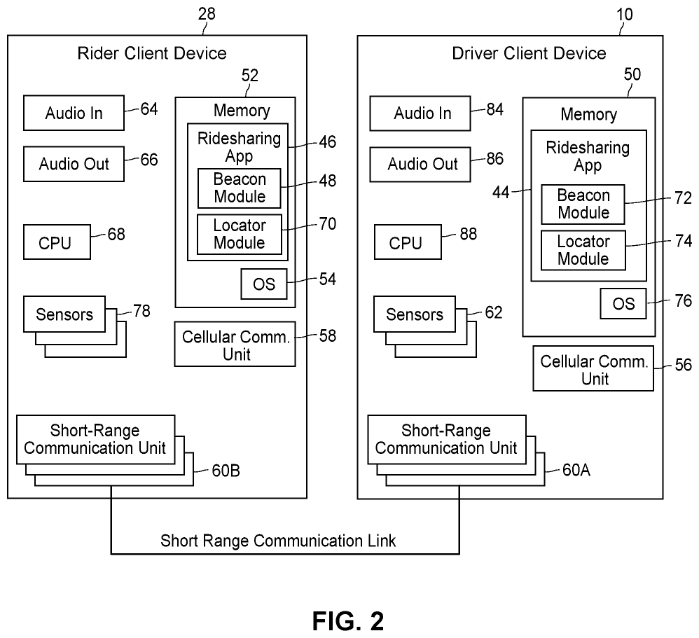

An example implementation of the driver client device 10, and the rider client device 28 is discussed next with reference to FIG. 2. The driver client device 10 can include a short-range communication unit 60A for communicating with the rider client device 28 via short-range communication links. The short-range communication unit 60A can support one or more communication schemes such as USB, Bluetooth™, Wi-Fi Direct, NFC, etc. In some embodiments, the driver client device 10 can communicate with the rider client device 28 using multiple communication schemes. For example, the driver client device 10 can communicate with the rider client device 28 using a radio communication link via the short-range communication unit 60A, such as Bluetooth™ (e.g., BLE). The driver client device 10 can also communicate with the rider client device 28 using an ultrasonic or near-ultrasonic communication via a microphone 84 and speakers 86. Both communications may identify the driver client device 10 to the rider client device 28, so that the rider client device 28 or a remote server can determine the device that is in the same vehicle with the rider client device 28.

The driver client device 10 can include audio input and output components such as a microphone 84 and speakers 86, for example to transmit and receive the ultrasonic or near-ultrasonic communications. Additionally, the driver client device 10 includes one or more processors or CPUs 88, one or more sensors 62 such as a GPS module, an accelerometer, a gyroscope, a magnetometer, an inertial measurement unit (IMU), a pressure sensor, etc., a memory 50, and a cellular communication unit 56 to transmit and receive data via a 3G cellular network, a 4G cellular network, or any other suitable network.

The memory 50 can store, for example, instructions of an operating system 76, and a ridesharing application 44. The ridesharing application may include a beacon module 72 and a locator module 74. While the beacon module 72 and locator module 74 are included in the ridesharing application 44, this is merely one example implementation for ease of illustration only. The memory 50 can store any suitable number of applications, and the beacon module 72 and the locator module 74 may be included in any suitable application to determine that another device is at the same location as the driver client device 10. Furthermore, the beacon module 72 and the locator module 74 may operate outside of a vehicle environment, and may determine that another device is at the same location as the client device that includes the beacon module 72 and the locator module 74 regardless of whether the client device is in a vehicle.

In any event, the beacon module 72 may transmit communications via short-range communication links which may be received at the rider client device 28 or any other client device within a communication range of the driver client device 10. The communications may include identification information to identify the driver client device 10. In some embodiments, the identification information is encrypted for example, using an Ephemeral Identifier (EID). The device which receives the communication from the beacon module 72, such as the rider client device 28 may provide the encrypted identification information to a remote server that decrypts the identification information to identify the device that transmitted the communication. As described above, the beacon module 72 may transmit a first communication via a radio communication link, such as BLE. The beacon module 72 may also transmit a second communication via an ultrasonic or near-ultrasonic communication link through the speakers 86. The beacon module 72 may modulate the ultrasonic or near-ultrasonic communication to encode identification information to identify the driver client device 10. In this manner, the receiving device such as the rider client device 28 may receive redundant communications from different short-range communication links so that at least one communication may be received if the beacon module 72 is unable to send one of the communications from one of the short-range communication links or the receiving device is unable to receive one of the communications. For example, when the radio is on in the vehicle or the driver is utilizing the speakers from the vehicle head unit 14 to make a phone call or for any other purpose, the beacon module 72 may be unable to transmit an ultrasonic or near-ultrasonic communication. Furthermore, by transmitting multiple types of communications via different communication links which are used to verify that the driver client device 10 and the rider client device 28 are in the same vehicle, it is more difficult to spoof the system since the spoofer would have to create multiple fraudulent signals.

The locator module 74 obtains signals to identify a device at the same location as the driver client device 10. More specifically, the locator module 74 may obtain a first communication from another device, such as the rider client device 28 via a first short-range communication link, such as a radio communication link. The first communication may include identification information to identify the device that transmitted the communication. In some embodiments, the identification information may be encrypted. The locator module 74 may obtain a second communication from the other device via a second short-range communication link, such as an ultrasonic or near-ultrasonic communication link. For example, the locator module 74 may include an audio filter such as a high-pass filter to pass through audio received at the microphone 84 that is in an ultrasonic frequency range (e.g., frequencies greater than 20 kHz) or a near-ultrasonic frequency range. The locator module 74 may then obtain identification information for the transmitting device which is encoded in the ultrasonic or near-ultrasonic communication. In some embodiments, the locator module 74 compares the communications to determine whether they came from the same device. In other embodiments, the locator module 74 provides the communications to a server device to determine the device that sent each communication, and determine whether the driver client device 10 is at the same location as another device.

Furthermore, the locator module 74 may obtain additional communication signals such as Wi-Fi, Bluetooth™, etc., from other devices within a communication range of the driver client device 10. The other devices may include a vehicle head unit 14, or any other suitable device acting as a Wi-Fi hotspot or broadcasting a Bluetooth™ signal. The locator module 74 may also collect sensor data from the one or more sensors 62 such as positioning data, velocity data, acceleration data, orientation data, gyroscope data, pressure data, etc. In some embodiments, the locator module 74 compares the sensor data and additional communication signals to sensor data and additional communication signals from another device to determine whether the two devices are obtaining the same or similar additional communication signals and/or sensor data. In other embodiments, the locator module 74 provides the additional communication signals and sensor data to a server device. The server device may then compare the additional communication signals obtained at the driver client device 10, and the sensor data collected at the driver client device 10 to additional communication signals obtained at the rider client device 28 or any other suitable client device, and sensor data collected at the rider client device 28 to determine whether the driver client device 10 is at the same location as the rider client device 28.

The software components 44, and 76 can include compiled instructions and/or instructions in any suitable programming language interpretable at runtime. In any case, the software components 44, and 76 execute on the one or more processors 88.

Further, the rider client device 28 can include a short-range communication unit 60B for communicating with the driver client device 10 via the short-range communication link Similar to the unit 60A, the short-range communication unit 60B can support one or more communication schemes such as USB, Bluetooth, Wi-Fi Direct, NFC, etc. The rider client device 28 can include audio input and output components such as a microphone 64 and speakers 66. Additionally, similar to the driver client device 10, the rider client device 28 includes one or more processors or CPUs 68, one or more sensors 78 such as a GPS module, an accelerometer, a gyroscope, a magnetometer, an IMU, a pressure sensor, etc., a memory 52, and a cellular communication unit 58 to transmit and receive data via a 3G cellular network, a 4G cellular network, or any other suitable network.

The memory 52 can store instructions of an operating system 54 and a ridesharing application 46, similar to the ridesharing application 44 in the driver client device 10. Similar to the ridesharing application 44 in the driver client device 10, the ridesharing application 46 may include a beacon module 48 and a locator module 70. While the beacon module 48 and locator module 70 are included in the ridesharing application 44, this is merely one example implementation for ease of illustration only. The memory 52 can store any suitable number of applications, and the beacon module 48 and the locator module 70 may be included in any suitable application to determine that another device is at the same location as the rider client device 28. Furthermore, the beacon module 48 and the locator module 70 may operate outside of a vehicle environment, and may determine that another device is at the same location as the client device that includes the beacon module 48 and the locator module 70 regardless of whether the client device is in a vehicle.

Similar to the beacon module 72 in the driver client device 10, the beacon module 48 may transmit communications via short-range communication links which may be received at the driver client device 10 or any other client device within a communication range of the rider client device 28. The communications may include identification information to identify the rider client device 28. In some embodiments, the identification information is encrypted for example, using an EID or other encryption methods. The device which receives the communication from the beacon module 48, such as the driver client device 10 may provide the encrypted identification information to a remote server that decrypts the identification information to identify the device that transmitted the communication. As described above, the beacon module 48 may transmit a first communication via a radio communication link, such as BLE. The beacon module 48 may also transmit a second communication via an ultrasonic or near-ultrasonic communication link through the speakers 66.

Additionally, similar to the locator module 74 in the driver client device 10, the locator module 70 obtains signals to identify a device at the same location as the rider client device 28. More specifically, the locator module 70 may obtain a first communication from another device, such as the driver client device 10 via a first short-range communication link, such as a radio communication link. The first communication may include identification information to identify the device that transmitted the communication. In some embodiments, the identification information may be encrypted using any suitable symmetric or asymmetric encryption techniques. The locator module 70 may obtain a second communication from the other device via a second short-range communication link, such as an ultrasonic or near-ultrasonic communication link. In some embodiments, the locator module 70 compares the communications to determine whether they came from the same device. In other embodiments, the locator module 70 provides the communications to a server device to determine the device that sent each communication, and determine whether the rider client device 28 is at the same location as another device.

Furthermore, the locator module 70 may obtain additional communication signals such as Wi-Fi, Bluetooth™, etc., from other devices within a communication range of the rider client device 28. The other devices may include a vehicle head unit 14, or any other suitable device acting as a Wi-Fi hotspot or broadcasting a Bluetooth™ signal. The locator module 70 may also collect sensor data from the one or more sensors 78 such as positioning data, velocity data, orientation data, pressure data, etc. In some embodiments, the locator module 70 compares the sensor data and additional communication signals to sensor data and additional communication signals from another device to determine whether the two devices are obtaining the same or similar additional communication signals and/or sensor data. In other embodiments, the locator module 70 provides the additional communication signals and sensor data to a server device. The server device may then compare the additional communication signals obtained at the rider client device 28, and the sensor data collected at the rider client device 28 to additional communication signals obtained at the driver client device 10 or any other suitable client device, and sensor data collected at the driver client device 10 to determine whether the rider client device 28 is at the same location as the driver client device 10.

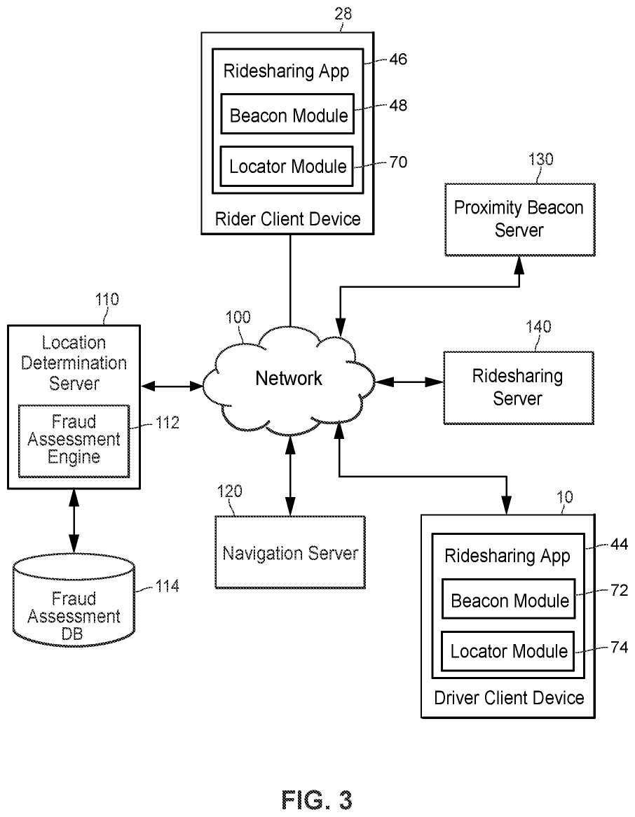

FIG. 3 illustrates an example communication system in which the driver client device 10 and the rider client device 28 can operate to determine they are at the same location. For ease of illustration, the driver client device 10, and the rider client device 28 are illustrated in a FIG. 3 in a simplified manner, i.e., without some of the components as illustrated in FIG. 2 and/or discussed elsewhere in this disclosure.

The driver client device 10 and the rider client device 28 have access to a wide area communication network 100 such as the Internet via a long-range wireless communication link (e.g., a cellular link) In the example configuration of FIG. 3, the driver client device 10 and the rider client device 28 communicate with a navigation server 120 that provides navigation data and map data, a location determination server 110 that verifies that multiple devices such as the driver client device 10 and the rider client device 28 are at the same location, a proximity beacon server 130 that decrypts encrypted identification information included in a communication via a short-range communication link, such as a BLE communication, and a ridesharing server 140 that connects drivers and passengers to arrange for a driver to transport a passenger to a destination.

More generally, the driver client device 10 and the rider client device 28 can communicate with any number of suitable servers. For example, in another embodiment, a map server (not shown) provides map data (e.g., in a vector graphics format), a traffic data server (not shown) provides traffic updates along a route, a weather data server (not shown) provides weather data and/or alerts, etc. In the embodiments described with respect to FIG. 3, the driver client device 10 and the rider client device 28 may be able to connect to the wide area communication network 100.

Also in some embodiments, the driver client device 10 and/or the rider client device 28 may communicate separately with each server, such as the location determination server 110, the proximity beacon server 130, and the ridesharing server 140. In other embodiments, the driver client device 10 and/or the rider client device 28 communicates with one of the server devices which then communicates with the other server devices to transmit and receive data for determining whether multiple devices are at the same location. For example, the driver client device 10 and/or the rider client device 28 may communicate with the location determination server 110 which then communicates with the proximity beacon server 130 to determine the identity of a device that transmitted a short-range communication. The location determination server 110 may also communicate with a ridesharing server 140 to receive ridesharing data and to alert the ridesharing server 140 that the passenger is in the driver's vehicle, for example.

The location determination server 110 may include a fraud assessment engine 112. The fraud assessment engine 112 may receive data from two or more devices 10, 28 which claim to be at the same location, and may analyze the data to verify that each of the devices is at the same location. More specifically, the devices 10, 28 may schedule transportation services with each other, for example via the ridesharing server 140. After transportation services have been scheduled between the devices 10, 28, the devices 10, 28 may automatically search for nearby devices providing radio and/or ultrasonic communications. The devices 10, 28 may also broadcast radio and/or ultrasonic communications. Then when one of the devices 10, 28 receives a radio and/or ultrasonic communication, the receiving device may provide the communication to the fraud assessment engine 112. In some embodiments, the devices 10, 28 may determine whether they are in the same location based on the received communications. In other embodiments, the devices 10, 28 forward the communications to the fraud assessment engine 112 without making a determination. Additionally, the devices 10, 28 may obtain other short-range communication signals from other devices within communication range of the devices 10, 28, such as a vehicle head unit 14. Furthermore, upon scheduling transportation services or receiving a radio and/or ultrasonic communication, the devices 10, 28 may collect sensor data, such as positioning data, velocity data, acceleration data, orientation data, gyroscope data, pressure data, etc., until the devices 10, 28 reach the destination. The sensor data may be indicative of the position, speed, acceleration, orientation, etc., of the vehicle.

Each of the devices 10, 28 may then provide the other communication signals received at the respective device and the sensor data collected at the respective device to the fraud assessment engine 112. The fraud assessment engine 112 may then determine whether the devices 10, 28 are at the same location based on the communications received at one or both of the devices, the other short-range communication signals obtained at each of the devices 10, 28, and the sensor data collected at each of the devices 10, 28. In some embodiments, the fraud assessment engine 112 may assign a fraud score to each of the received radio communications, the received ultrasonic or near-ultrasonic communications, the other communication signals, and the sensor data. The fraud scores may then be weighted, combined, or aggregated in any suitable manner to generate an overall fraud score for determining a risk of fraud. In some embodiments, the received radio communications and the received ultrasonic or near-ultrasonic communications may be weighted higher than the other communication signals and the sensor data.

In other embodiments, the fraud assessment engine 112 may assign a fraud score to the received radio communications and the received ultrasonic or near-ultrasonic communications. The fraud assessment engine 112 may then adjust the assigned fraud score based on the other communication signals and the sensor data. For example, the fraud assessment engine 112 may assign an initial fraud score based on the received radio communications and the received ultrasonic or near-ultrasonic communication. The fraud assessment engine 112 may then increase the initial fraud score by a predetermined increment each time both devices 10, 28 receive a communication signal from the same source. The fraud assessment engine 112 may also decrease the initial fraud score in proportion to the difference in measured values for a particular type of sensor data (e.g., acceleration) collected at each of the devices 10, 28 at a particular point in time. The fraud assessment engine 112 may then generate the overall score based on the adjusted initial fraud score.

Also in some embodiments, the fraud assessment engine 112 may obtain weights and/or equations for combining the fraud scores to general the overall fraud score from a fraud assessment database 114. The fraud assessment database 114 may also include sensor data thresholds for comparing each type of sensor data collected at the client devices 10, 28.

The fraud assessment engine 112 may assign a fraud score to the radio communications by determining the identity of the device transmitting a particular radio communication. As described above, the radio communication may include identification information for identifying the transmitting device. In some embodiments, the identification information may be encrypted for example, using an EID. If the identification information is encrypted, the fraud assessment engine 112 may provide the encrypted identification information (also referred to herein as a “cryptographically generated identifier”) to the proximity beacon server 130 to decrypt the identification information and provide the identity of the transmitting device to the fraud assessment engine 112. For example, the transmitting device may use a cryptographic private key to encrypt a pseudo-random function of the current time. The transmitting device may also share the cryptographic private key with the proximity beacon server 130. Accordingly, the proximity beacon server 130 may store several cryptographic private keys and the identities of the corresponding transmitting devices that use each of the cryptographic private keys. In response to receiving encrypted identification information and the time in which the encrypted identification information was transmitted, the proximity beacon server 130 may identify the cryptographic private key used to encrypt the pseudo-random function of the current time. The proximity beacon server 130 may then obtain the identity of the corresponding transmitting device that uses the identified cryptographic private key, and may provide the identity of the corresponding transmitting device to the fraud assessment engine 112.

In any event, if the transmitting device is the device used to schedule the transportation services with the receiving device, the fraud assessment engine 112 may assign a low fraud score to the radio communications. If no transmitting device is identified, the fraud assessment engine 112 may assign a medium fraud score to the radio communications which is higher than the low fraud score. On the other hand, if the transmitting device is not the device used to schedule the transportation services with the receiving device, the fraud assessment engine 112 may assign a high fraud score to the radio communications which is higher than the medium fraud score.

Additionally, the fraud score for the radio communications may be based on whether one of the devices 10, 28 received a radio communication from the other or both devices 10, 28 received radio communications from each other. For example, if both devices 10, 28 received radio communications from each other, the fraud assessment engine 112 may decrease the fraud score for the radio communications.

The fraud assessment engine 112 may assign a fraud score to the ultrasonic or near-ultrasonic communications in a similar manner as the fraud score for the radio communications. As described above, the ultrasonic or near-ultrasonic communication may include identification information for identifying the transmitting device. In some embodiments, the identification information may be encrypted for example, using an EID. If the identification information is encrypted, the fraud assessment engine 112 may provide the encrypted identification information to the proximity beacon server 130 to decrypt the identification information and provide the identity of the transmitting device to the fraud assessment engine 112.

In any event, if the transmitting device is the device used to schedule the transportation services with the receiving device, the fraud assessment engine 112 may assign a low fraud score to the ultrasonic or near-ultrasonic communications. If no transmitting device is identified, the fraud assessment engine 112 may assign a medium fraud score to the ultrasonic or near-ultrasonic communications which is higher than the low fraud score. On the other hand, if the transmitting device is not the device used to schedule the transportation services with the receiving device, the fraud assessment engine 112 may assign a high fraud score to the ultrasonic communications which is higher than the medium fraud score.

Additionally, the fraud score for the ultrasonic or near-ultrasonic communications may be based on whether one of the devices 10, 28 received an ultrasonic or near-ultrasonic communication from the other or both devices 10, 28 received ultrasonic or near-ultrasonic communications from each other. For example, if both devices 10, 28 received ultrasonic or near-ultrasonic communications from each other, the fraud assessment engine 112 may decrease the fraud score for the ultrasonic or near-ultrasonic communications.

The fraud assessment engine 112 may assign a fraud score to the other communication signals by comparing the other communication signals received at each of the devices 10, 28. More specifically, the fraud score for the other communication signals may be based on the number of other communication signals which were obtained by both devices 10, 28 and/or the number of times the devices 10, 28 received other communication signals from the same source. For example, if both the driver client device 10 and the rider client device 28 obtained a communication signal from the vehicle head unit 14, then the number of other communication signals which were obtained by both devices 10, 28 is one. In some embodiments, the fraud assessment engine 112 may assign a low fraud score to the other communication signals if at least one other communication signal was obtained by both devices 10, 28 and a high fraud score to the other communication signals if none of the other communication signals were obtained by both devices 10, 28. In other embodiments, the fraud assessment engine 112 may decrease the fraud score in proportion to the number of other communication signals which were obtained by both devices 10, 28 and/or the number of times the devices 10, 28 received other communication signals from the same source.

The fraud assessment engine 112 may assign a fraud score to the sensor data by comparing the sensor data received at each of the devices 10, 28. More specifically, the fraud assessment engine 112 may compare each type of sensor data (e.g., positioning data, acceleration data, velocity data, orientation data, gyroscope data, etc.) for the devices 10, 28 at one or more points in time before the devices 10, 28 reached the destination. For example, the fraud assessment engine 112 may compare the acceleration of the driver client device 10 to the acceleration of the rider client device 28 at a particular point in time. In some embodiments, if the difference between the accelerations is less than a threshold difference metric, the fraud assessment engine 112 may assign a low acceleration score for the particular point in time. If the difference between the accelerations is greater than or equal to the threshold difference metric, the fraud assessment engine 112 may assign a high acceleration score for the particular point in time. In other embodiments, the fraud assessment engine 112 may increase the acceleration score in proportion to the difference between the accelerations for the devices 10, 28 at the particular point in time. The fraud assessment engine 112 may then combine scores for each type of sensor data at one or more points in time to generate the fraud score for the sensor data. For example, the fraud assessment engine 112 may assign a fraud score to the sensor data based on the Euclidean distance between the sensor data received at the driver client device 10 and the sensor data received at the rider client device 28, where the Euclidean distance is the square root of the sum of the squares of the differences in measured values between each type of sensor data (e.g., differences in acceleration, velocity, orientation, etc. detected at the driver client device 10 and the rider client device 28).

Then, as mentioned above, the fraud assessment engine 112 may weight, combine, or aggregate the fraud scores in any suitable manner to generate an overall fraud score. The fraud assessment engine 112 may determine a risk of fraud based on the overall fraud score. For example, if the overall fraud score exceeds a threshold fraud score, the fraud assessment engine 112 may identify fraud. On the other hand, if the overall fraud score does not exceed the threshold fraud score, the fraud assessment engine 112 may not identify fraud and may determine that the devices 10, 28 are at the same location. In another example, the fraud assessment engine 112 may determine a likelihood of fraud in proportion to the overall fraud score.

In some embodiments, the fraud assessment engine 112 may provide the fraud determination or the likelihood of fraud to the ridesharing server 140. The ridesharing server 140 may then analyze the fraud determination or the likelihood of fraud to determine whether the driver and/or the passenger qualify for ridesharing benefits. Ridesharing benefits may include promotions for vehicles that have more than one occupant. For example, carpool rides in some areas allow access to high occupancy vehicle (HOV) lanes, discounts at toll roads, etc. If the ridesharing server 140 receives an indication of fraud or a likelihood of fraud that exceeds a likelihood threshold, the ridesharing server 140 may deny the ridesharing benefits to the driver and/or passenger. On other hand, if the ridesharing server 140 receives an indication that the driver and passenger are in the vehicle together or a likelihood of fraud that is less than the likelihood threshold, the ridesharing server 140 may provide the ridesharing benefits to the driver and/or passenger.

In an exemplary scenario, John Doe requests a ride to his office from a carpooling service via a ridesharing application on his client device. The carpooling service identifies Jane Smith who is also traveling to the same office building and does not live far from John Doe. Jane Smith accepts the request via the ridesharing application on her client device and drives to pick up John Doe. When John enters Jane's vehicle, neither of them needs to select a user control indicating that John has been picked up. Instead, one or both client devices transmit communications, such as radio communications and ultrasonic or near-ultrasonic communications which are received by the other client device. Both client devices also detect other communication signals from nearby devices and detect sensor data, such as the speed, acceleration, and orientation of the vehicle at different points in time along the ride. For example, John's client device receives a BLE communication identifying Jane's client device as the transmitter and receives an ultrasonic communication also identifying Jane's client device as the transmitter. The client devices then transmit the received communications, other communication signals, and sensor data to a location determination server 110 which analyzes each type of data to identify a risk of fraud. Because the communications received at John Doe's client device identify Jane Smith's client device as the transmitter, both client devices received other communication signals from the same vehicle head unit, and both client devices detected similar sensor data, the location determination server 110 determines that both client devices are at the same location and that Jane Smith picked up John Doe. Accordingly, Jane Smith may be paid for her carpooling services and may receive ridesharing benefits for transporting John Doe to his destination.

In another exemplary scenario, Bob Jackson spoofs GPS signals to falsely claim that Bob Jackson picked up John Doe and took him to a destination. However, the location determination server does not receive an indication of a communication sent from Bob Jackson's client device to John Doe's client device or vice versa. Accordingly, the location determination server 110 identifies a risk of fraud and may deny ridesharing benefits to Bob Jackson and/or John Doe.

### Example Message Diagram

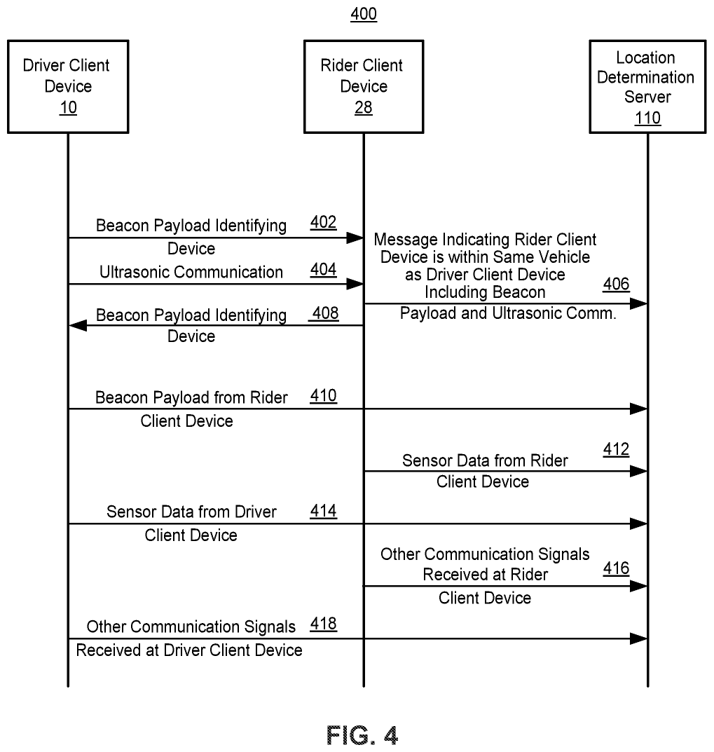

FIG. 4 illustrates a messaging diagram 400 depicting an example sequence of events for the location determination server 110 to verify that the client devices 10, 28 are at the same location. The driver client device 10 may begin broadcasting 402 a radio communication, such as a BLE communication to devices within a communication range of the driver client device 10. The radio communication may identify the driver client device 10. In some embodiments, the driver client device 10 begins broadcasting the radio communication upon accepting the request to pick up the rider. In this manner, the rider client device 28 may receive the radio communication once the rider enters the vehicle. In other embodiments, the location determination server 110 coordinates the transmission of radio communications by the driver client device 10 and the rider client device 28, so that the driver client device 10 and the rider client device 28 do not transmit radio communications at the same time. The location determination server 110 may receive indications of the current locations of the driver client device 10 and the rider client device 28, and may instruct the driver client device 10 to broadcast the radio communication when the driver client device 10 and the rider client device 28 are within a threshold distance of each other. In yet other embodiments, the driver client device 10 receives an indication of the current location of the rider client device 28, and may broadcast the radio communication when the rider client device 28 is within a threshold distance of the driver client device 10.

In addition to broadcasting 402 a radio communication, the driver client device 10 broadcasts 404 an ultrasonic or near-ultrasonic communication. The driver client device 10 may modulate the ultrasonic or near-ultrasonic communication to encode identification information to identify the driver client device 10. In some embodiments, the driver client device 10 begins broadcasting the ultrasonic or near-ultrasonic communication after broadcasting the radio communication. In other embodiments, the location determination server 110 coordinates the transmission of the ultrasonic or near-ultrasonic communications by the driver client device 10.

In response to receiving the radio communication and the ultrasonic or near-ultrasonic communication from the driver client device 10, the rider client device 28 may compare the identification information from both communications to determine whether the identification information corresponds to the same device and corresponds to the device that accepted the request to pickup the rider. If the identification information from both communications corresponds to the same device and corresponds to the device that accepted the request to pickup the rider, the rider client device 28 may transmit 406 a message to the location determination server 110 indicating the driver client device 10 and the rider client device 28 are in the same vehicle, and including the radio and ultrasonic communications. In other embodiments, the rider client device 28 forwards the radio and ultrasonic communications to the location determination server 110, and the location determination server 110 determines if the identification information from both communications corresponds to the same device and corresponds to the device that accepted the request to pickup the rider. For example, if the identification information in one of the communications is encrypted, the location determination server 110 may provide the encrypted identification information to the proximity beacon server 130 to identify the device that transmitted the communication.

In any event, the rider client device 28 may begin broadcasting 408 a radio communication, such as a BLE communication to devices within a communication range of the rider client device 28. The radio communication may identify the rider client device 28. In some embodiments, the rider client device 28 begins broadcasting the radio communication upon receiving the radio communication or the ultrasonic communication from the driver client device 10. In other embodiments, the location determination server 110 coordinates the transmission of radio communications by the driver client device 10 and the rider client device 28, so that the driver client device 10 and the rider client device 28 do not transmit radio communications at the same time. In yet other embodiments, the rider client device 28 receives an indication of the current location of the driver client device 10, and may broadcast the radio communication when the driver client device 10 is within a threshold distance of the rider client device 28. The rider client device 28 may also broadcast an ultrasonic communication that encodes identification information to identify the rider client device 28.

In response to receiving the radio communication and/or the ultrasonic communication from the rider client device 28, the driver client device 10 may compare the identification information from both communications to determine whether the identification information corresponds to the same device and corresponds to the device that requested a ride. If the identification information from both communications corresponds to the same device and corresponds to the device that requested a ride, the driver client device 10 may transmit 410 a message to the location determination server 110 indicating the driver client device 10 and the rider client device 28 are in the same vehicle, and including the radio and ultrasonic communications. In other embodiments, the driver client device 10 forwards the radio and ultrasonic communications to the location determination server 110, and the location determination server 110 determines if the identification information from both communications corresponds to the same device and corresponds to the device that requested the ride. For example, if the identification information in one of the communications is encrypted, the location determination server 110 may provide the encrypted identification information to the proximity beacon server 130 to identify the device that transmitted the communication.

In addition to providing communications received at the driver client device 10 or the rider client device 28 to the location determination server 110, the rider client device 28 transmits 412 sensor data received at the rider client device 28 to the location determination server 110, and the driver client device 10 transmits 414 sensor data received at the driver client device 10 to the location determination server 110. The rider client device 28 and the driver client device 10 may each detect sensor data over the same time period, such as from the time the driver accepts the request to pick up the rider until the driver client device 10 and/or the rider client device 28 reaches the destination. In other embodiments, the time period may be from a time in which the driver client device 10 and the rider client device 28 are within a threshold distance of each other until the driver client device 10 and/or the rider client device 28 reaches the destination. In yet other embodiments, the time period may be from a time in which the driver client device 10 and/or the rider client device 28 receives a radio or ultrasonic communication from the other client device 10, 28 until the driver client device 10 and/or the rider client device 28 reaches the destination.

In any event, both client devices 10, 28 may detect sensor data from the GPS module, accelerometer, gyroscope, magnetometer, IMU, pressure sensor, etc., to identify positions, velocities, accelerations, orientations, pressures, etc., from the respective client devices 10, 28 at various points in time along the route to the destination.

Furthermore, the rider client device 28 transmits 416 other communication signals received at the rider client device 28 and/or identification information of the source of each received communication signal (e.g., the vehicle head unit 14) to the location determination server 110. Likewise, the driver client device 10 transmits 418 other communication signals received at the driver client device 10 and/or identification information of the source of each received communication signal to the location determination server 110.

The location determination server 110 then verifies that the driver client device 10 and the rider client device 28 are at the same location. More specifically, as described above, the location determination server 110 verifies that the driver client device 10 and the rider client device 28 are at the same location based on the communications received at one or both of the devices, the other short-range communication signals obtained at each of the devices 10, 28, and the sensor data collected at each of the devices 10, 28. In some embodiments, the location determination server 110 may assign a fraud score to each of the received radio communications, the received ultrasonic communications, the other communication signals, and the sensor data. The fraud scores may then be weighted, combined, or aggregated in any suitable manner to generate an overall fraud score for determining a risk of fraud. In some embodiments, the received radio communications and the received ultrasonic communications may be weighted higher than the other communication signals and the sensor data.

### Example Methods for Securely Determining Whether Two or More Devices are at the Same Location

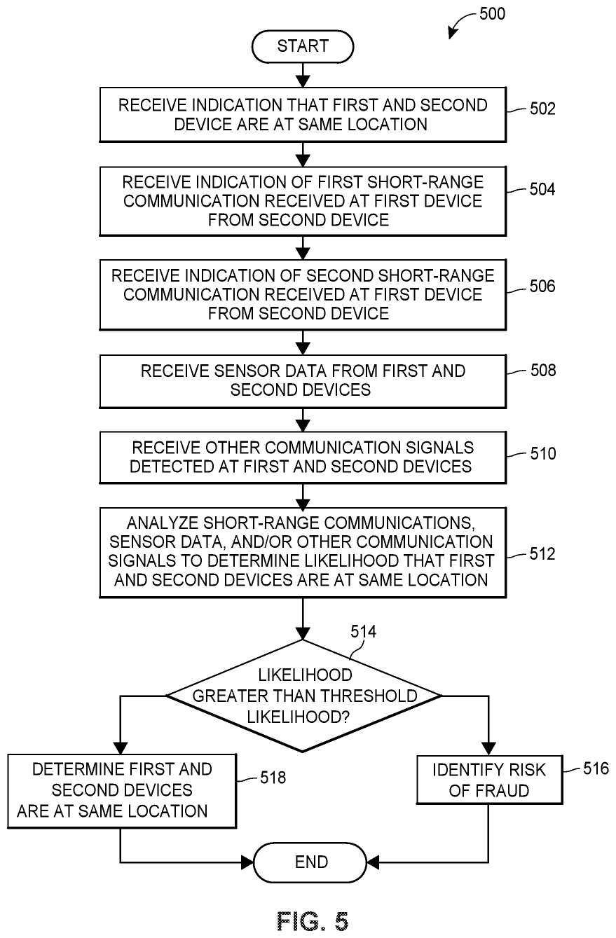

FIG. 5 illustrates a flow diagram of an example method 500 for securely determining whether two or more devices are at the same location. The method can be implemented in a set of instructions stored on a computer-readable memory and executable at one or more processors of the location determination server 110. For example, the method can be implemented by the fraud assessment engine 112.

At block 502, the location determination server 110 receives an indication that a first client device and a second client device are at the same location. The indication may be received from the first client device. The indication may include an indication of a first short-range communication received at the first client device from the second client device (block 504), and an indication of a second short-range communication received at the first client device from the second client device (block 506). The first short-range communication may be a radio communication, such as BLE communication, and the second short-range communication may be an ultrasonic or near-ultrasonic communication. Both the radio communication and the ultrasonic communication may include identification information identifying the device that transmitted the communication. In some embodiments, the identification information may be encrypted identification information. Accordingly, the location determination server 110 may provide the encrypted identification information to the proximity beacon server 130 to decrypt the identification information and provide the identity of the transmitting device to the location determination server 110.

In some embodiments, location determination server 110 may also receive an indication from the second client device 10 including a third short-range communication received at the second client device from the first client device, and a fourth short-range communication received at the second client device from the first client device. The third short-range communication may be a radio communication, such as BLE communication, and the fourth short-range communication may be an ultrasonic or near-ultrasonic communication. Both the radio communication and the ultrasonic communication may include identification information identifying the device that transmitted the communication.

Then at block 508, the location determination server 110 may receive sensor data collected at the first client device from the first client device, and sensor data collected at the second client device from the second client device. The sensor data may include positioning data, velocity data, acceleration data, orientation data, gyroscope data, pressure data, etc., collected over a particular time period. For example, when the first and second client devices schedule transportation services with each other, the time period may be from the time the driver accepts the request to pick up the rider or from the time the driver and rider are within a threshold distance of each other until the first client device and/or the second client device reaches the destination.

The location determination server 110 may also receive other communication signals received at the first client device from the first client device, and other communication signals received at the second client device from the second client device (block 510). The other communication signals may be short-range communication signals such as Wi-Fi, Bluetooth™, etc., from other devices within a communication range of the device receiving the signal. The other devices may include a vehicle head unit 14, or any other suitable device acting as a Wi-Fi hotspot or broadcasting a Bluetooth™ signal.

At block 512, the location determination server 110 and, more specifically, the fraud assessment engine 112 may analyze the communications received at one or both of the devices, the other short-range communication signals obtained at each of the devices, and the sensor data collected at each of the devices to determine a likelihood that the first and second client device are at the same location. In some embodiments, the fraud assessment engine 112 may assign a fraud score to each of the received radio communications, the received ultrasonic communications, the other communication signals, and the sensor data. The fraud scores may then be weighted, combined, or aggregated in any suitable manner to generate an overall fraud score for determining a risk of fraud. In some embodiments, the fraud assessment engine 112 may determine a likelihood of fraud in proportion to the overall fraud score.

The fraud assessment engine 112 may then compare the likelihood of fraud to a likelihood threshold (block 514). If the likelihood is greater than the likelihood threshold, the fraud assessment engine 112 may identify a risk of fraud (block 516). Otherwise, the fraud assessment engine may determine that the first and second client devices are at the same location (block 518). In some embodiments, the fraud assessment engine 112 may provide the fraud determination or the likelihood of fraud to the ridesharing server 140. The ridesharing server 140 may then analyze the fraud determination or the likelihood of fraud to determine whether the driver and/or the passenger qualify for ridesharing benefits. Ridesharing benefits may include promotions for vehicles that have more than one occupant. For example, carpool rides in some areas allow access to high occupancy vehicle (HOV) lanes, discounts at toll roads, etc. If the ridesharing server 140 receives an indication of a risk of fraud or a likelihood of fraud that exceeds a likelihood threshold, the ridesharing server 140 may deny the ridesharing benefits to the driver and/or passenger. On other hand, if the ridesharing server 140 receives an indication that the driver and passenger are in the vehicle together or a likelihood of fraud that is less than the likelihood threshold, the ridesharing server 140 may provide the ridesharing benefits to the driver and/or passenger. In other embodiments, the location determination server 110 may deny or provide ridesharing benefits to the driver and/or passenger based on the risk of fraud.

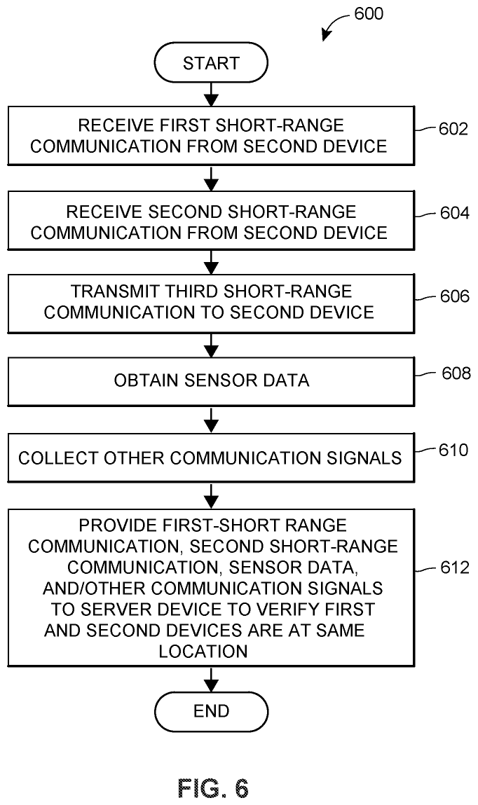

FIG. 6 illustrates a flow diagram of an example method 600 for providing information indicating that two or more devices are at the same location. The method can be implemented in a set of instructions stored on a computer-readable memory and executable at one or more processors of the driver client device 10 and/or the rider client device 28. For example, the method can be implemented by the beacon module 48, 72 and the locator module 70, 74.

At block 602, a first client device receives a first short-range communication from a second client device. The first client device may also receive a second short-range communication from the second client device (block 604). The first short-range communication may be a radio communication, such as BLE communication, and the second short-range communication may be an ultrasonic or near-ultrasonic communication. Both the radio communication and the ultrasonic communication may include identification information identifying the device that transmitted the communication. In some embodiments, the identification information may be encrypted identification information.

At block 606, the first client device transmits a third short-range communication to the second client device, such as a radio communication. In some embodiments, the first client device may also transmit a fourth short-range communication to the second client device, such as an ultrasonic or near-ultrasonic communication. Like the first and second short-range communications, the third and fourth short-range communications may include identification information identifying the device that transmitted the communication.

Additionally, the first client device may obtain sensor data over a particular time period (block 608). The sensor data may include positioning data, velocity data, acceleration data, orientation data, gyroscope data, pressure data, etc. For example, when the first and second client devices schedule transportation services with each other, the time period may be from the time the driver accepts the request to pick up the rider or from the time the driver and rider are within a threshold distance of each other until the first client device and/or the second client device reaches the destination.

Furthermore, the first client device may receive other communication signals (block 610), such as short-range communication signals such as Wi-Fi, Bluetooth™, etc., from other devices within a communication range of the device receiving the signal. The other devices may include a vehicle head unit 14, or any other suitable device acting as a Wi-Fi hotspot or broadcasting a Bluetooth™ signal.

Then at block 612, the first client device provides the first short-range communication, the second short-range communication, the sensor data collected over the particular time period, and/or the other communication signals to a server device, such as the location determination server 110 for the location determination server 110 to verify that the first and second client devices are at the same location.

In some embodiments, the second client device may provide the third short-range communication, the fourth short-range communication, sensor data collected at the second client device over the same particular time period as the sensor data was collected at the first client device, and/or other communication signals received at the second client device. The location determination server 110 may then analyze the first, second, third, and/or fourth short-range communications, may compare the sensor data collected at the first client device and the second client device, and may compare the other communication signals received at the first and second client devices to determine a likelihood that the first and second client device are at the same location and/or a risk of fraud based on the likelihood.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 500 and 600 may include one or more function blocks, modules, individual functions or routines in the form of tangible computer-executable instructions that are stored in a non-transitory computer-readable storage medium and executed using a processor of a computing device (e.g., a server device, a personal computer, a smart phone, a tablet computer, a smart watch, a mobile computing device, or other client computing device, as described herein). The methods 500 and 600 may be included as part of any backend server (e.g., a location determination server, a ridesharing server, a map data server, a navigation server, or any other type of server computing device, as described herein), client device modules of the example environment, for example, or as part of a module that is external to such an environment. Though the figures may be described with reference to the other figures for ease of explanation, the methods 500 and 600 can be utilized with other objects and user interfaces. Furthermore, although the explanation above describes steps of the methods 500 and 600 being performed by specific devices (such as a location determination server 110, a driver client device 10, or a rider client device 28), this is done for illustration purposes only. The blocks of the methods 500 and 600 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for determining whether two or more devices are at the same location through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for securely determining whether two or more devices are at a same location, the method comprising:
generating, by a first client device, identification information for the first client device;
transmitting, by a first client device to a second client device, a first short-range communication via a first type of short-range communication link including the identification information for the first client device; and
transmitting, by the first client device to the second client device, a second short-range communication via a second type of short-range communication link including the identification information for the first client device to provide proof that the first and second client devices are at a same location.

2. The method of claim 1, wherein the second client device transmits an indication to a server device that the first and second client devices are at the same location with the first and second short-range communications as proof that the first and second client devices are at the same location.

3. The method of claim 1, further comprising:
transmitting, by the first client device to a server device, a first set of sensor data collected by the first client device.

4. The method of claim 1, further comprising:
encrypting, by the first client device, the identification information in the first short-range communication using an Ephemeral Identifier (EID), such that only a device with the cryptographic key can decrypt the encrypted identification information.

5. The method of claim 1, further comprising:
modulating, by the first client device, the second short-range communication to encode the identification information.

6. The method of claim 1, wherein the first type of short-range communication link is a radio communication link and the second type of short-range communication link is an ultrasonic communication link.

7. The method of claim 1, wherein the first client device transmits the first or second short-range communications in response to determining the second client device is within a threshold distance of the first client device.

8. A first client device for securely determining whether two or more devices are at a same location, the server device comprising:
one or more processors; and
a non-transitory computer-readable memory coupled to the one or more processors and storing instructions thereon that, when executed by the one or more processors, cause the first client device to:
generate identification information for the first client device;
transmit, to a second client device via a first type of short-range communication link, a first short-range communication including the identification information for the first client device; and
transmit, to the second client device via a second type of short-range communication link, a second short-range communication including the identification information for the first client device to provide proof that the first and second client devices are at a same location.

9. The first client device of claim 8, wherein the second client device transmits an indication to a server device that the first and second client devices are at the same location with the first and second short-range communications as proof that the first and second client devices are at the same location.

10. The first client device of claim 8, wherein the instructions further cause the first client device to:
transmit, to a server device, a first set of sensor data collected by the first client device.

11. The first client device of claim 8, wherein the instructions further cause the first client device to:
encrypt the identification information in the first short-range communication using an Ephemeral Identifier (EID), such that only a device with the cryptographic key can decrypt the encrypted identification information.

12. The first client device of claim 8, wherein the instructions further cause the first client device to:
modulate the second short-range communication to encode the identification information.

13. The first client device of claim 8, wherein the first type of short-range communication link is a radio communication link and the second type of short-range communication link is an ultrasonic communication link.

14. The first client device of claim 8, wherein the first client device transmits the first or second short-range communications in response to determining the second client device is within a threshold distance of the first client device.

15. A method for securely determining whether two or more devices are at a same location, the method comprising:
receiving, at a first client device, a first short-range communication from a second client device via a first type of short-range communication link;
receiving, at the first client device, a second short-range communication from the second client device via a second type of short-range communication link, wherein the first and second short-range communications identify the second client device;
determining, by the first client device, that the first and second client devices are at a same location based on the first and second short-range communications from the second client device; and
transmitting, by the first client device to a server device, an indication that the first and second client devices are at the same location with information from the first and second short-range communications to verify that the first and second client devices are at the same location.

16. The method of claim 15, further comprising:
transmitting, by the first client to the server device, a first set of sensor data collected at the first client device.

17. The method of claim 15, wherein the first client device determines that the first and second client devices are at the same location in response to determining that the first and second short-range communications identify the second client device.

18. The method of claim 15, further comprising:
transmitting, by the first client device to the second client device, a third short-range communication via the first type of short-range communication link including identification information for the first client device; and
transmitting, by the first client device to the second client device, a fourth short-range communication via the second type of short-range communication link including the identification information for the first client device.

19. The method of claim 15, wherein the first type of short-range communication link is a radio communication link and the second type of short-range communication link is an ultrasonic communication link.

20. The method of claim 19, wherein receiving the second short-range communication includes:
receiving audio at the first client device; and
filtering the audio with a high-pass filter to pass through a portion of the audio that is in an ultrasonic frequency range to receive the second short-range communication.
